(19) United States
(12) Patent Application Publication
(10) Pub. No.: US 2024/0129439 A1
(43) Pub. Date: Apr. 18, 2024

(54) TERMINAL APPARATUS

(71) Applicant: TOYOTA JIDOSHA KABUSHIKI KAISHA, Toyota-shi (JP)

(72) Inventor: Wataru KAKU, Musashino-shi (JP)

(73) Assignee: TOYOTA JIDOSHA KABUSHIKI KAISHA, Toyota-shi (JP)

(21) Appl. No.: 18/485,058

(22) Filed: Oct. 11, 2023

(30) Foreign Application Priority Data
Oct. 18, 2022 (JP) 2022-167115

(51) Int. Cl. H04N 7/15; G06F 3/01

(52) U.S. Cl. CPC H04N 7/157; G06F 3/013

(57) ABSTRACT

A terminal apparatus includes a communication interface and a controller configured to communicate using the communication interface. The controller receives information for generating a 3D model that represents another user who participates in a call in a virtual space using another terminal apparatus and also represents a direction of focus of the another user and outputs information for displaying an image for display obtained by rendering the virtual space in which the 3D model is placed to be focusing in the direction of focus.

### CROSS-REFERENCE TO RELATED APPLICATION

This application claims priority to Japanese Patent Application No. 2022-167115, filed on Oct. 18, 2022, the entire contents of which are incorporated herein by reference.

### TECHNICAL FIELD

The present disclosure relates to a terminal apparatus.

### BACKGROUND

A method is known for computers at multiple points to communicate via a network and hold calls in a virtual space on the network. Various forms of technology have been proposed to improve the convenience for users who participate in calls in this way on the network. For example, Patent Literature (PTL) 1 discloses technology for estimating the point of regard from the user's line of sight and head orientation, estimating a focus target on which the user focuses from the point of regard, and increasing the volume of the focus target in a videoconferencing system in which a plurality of users participate.

### CITATION LIST

### Patent Literature

PTL 1: JP 2015-046822 A

### SUMMARY

There is room for improvement in user convenience and in the realistic feel of a call in virtual space on a network.

It would be helpful to provide a terminal apparatus and the like that contribute to user convenience and the realistic feel of a call in virtual space.

A terminal apparatus in the present disclosure includes:
a communication interface; and
a controller configured to communicate using the communication interface, wherein
the controller is configured to receive information for generating a 3D model that represents another user who participates in a call in a virtual space using another terminal apparatus and also represents a direction of focus of the another user, and output information for displaying an image for display obtained by rendering the virtual space in which the 3D model is placed to be focusing in the direction of focus.

According to the terminal apparatus and the like in the present disclosure, user convenience and the realistic feel of a call in virtual space can be improved.

### BRIEF DESCRIPTION OF THE DRAWINGS

In the accompanying drawings:

FIG. 1 is a diagram illustrating a configuration example of a virtual space call system;

FIG. 2 is a sequence diagram illustrating an operation example of the virtual space call system;

FIG. 3A is a flowchart illustrating an example of operations of a terminal apparatus;

FIG. 3B is a flowchart illustrating an example of operations of a terminal apparatus; and

FIG. 4 is a diagram illustrating an example of a virtual space image.

### DETAILED DESCRIPTION

Embodiments are described below.

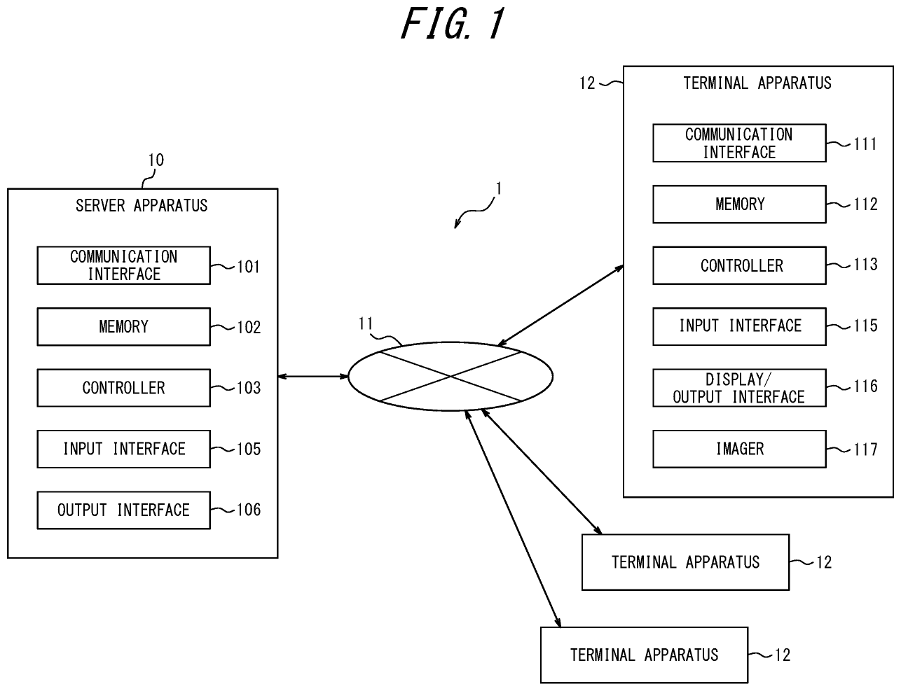

FIG. 1 is a diagram illustrating an example configuration of a virtual space call system 1 in an embodiment. The virtual space call system 1 includes a plurality of terminal apparatuses 12 and a server apparatus 10 that are connected via a network 11 to enable communication of information with each other. The virtual space call system 1 is a system for providing call events in a virtual space in which users can participate using the terminal apparatuses 12. In the call event in virtual space, each user is represented by a three-dimensional model that stands for the user.

The server apparatus 10 is, for example, a server computer that belongs to a cloud computing system or other computing system and functions as a server that implements various functions. The server apparatus 10 may be configured by two or more server computers that are communicably connected to each other and operate in cooperation. The server apparatus 10 transmits and receives, and performs information processing on, information necessary to provide a call event.

Each terminal apparatus 12 is an information processing apparatus provided with communication functions and is used by a user who participates in a call in the virtual space provided by the server apparatus 10. The terminal apparatus 12 is, for example, an information processing terminal, such as a smartphone or a tablet terminal, or an information processing apparatus, such as a personal computer.

The network 11 may, for example, be the Internet or may include an ad hoc network, a local area network (LAN), a metropolitan area network (MAN), other networks, or any combination thereof.

In the present embodiment, the terminal apparatus 12 includes a communication interface 111 and a controller 113. The controller 113 is configured to receive information for generating a 3D model that represents another user (other user) who participates in a call in a virtual space using another terminal apparatus and also represents a direction of focus of the other user, and outputs information for displaying an image for display obtained by rendering the virtual space in which the 3D model is placed to be focusing in the direction of focus. When the user of the terminal apparatus 12 (corresponding user) makes a call with a plurality of other users, a virtual space is displayed to the corresponding user with 3D models representing the other users placed to be facing the direction of focus of the other users. For example, when a certain other user is focusing on the 3D model of another user, the 3D model of the certain other user faces the 3D model on which the certain other user is focusing in the virtual space that is displayed. The corresponding user can thereby more realistically experience the relationship between other users in the call in which the corresponding user is participating and can more easily grasp and predict the development of the conversation. User convenience and the realistic feel of a call in virtual space can therefore be improved.

Respective configurations of the server apparatus 10 and the terminal apparatuses 12 are described in detail.

The server apparatus 10 includes a communication interface 101, a memory 102, a controller 103, an input interface 105, and an output interface 106. These configurations are appropriately arranged on two or more computers in a case in which the server apparatus 10 is configured by two or more server computers.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the terminal apparatuses 12 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The input interface 105 includes one or more interfaces for input. The interface for input is, for example, a physical key, a capacitive key, a pointing device, a touch screen integrally provided with a display, or a microphone that receives audio input. The input interface 105 accepts operations to input information used for operation of the server apparatus 10 and transmits the inputted information to the controller 103.

The output interface 106 includes one or more interfaces for output. The interface for output is, for example, a display or a speaker. The display is, for example, a Liquid Crystal Display (LCD) or an organic Electro Luminescent (EL) display. The output interface 106 outputs information obtained by the operations of the server apparatus 10.

The functions of the server apparatus 10 are realized by a processor included in the controller 103 executing a control program. The control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

Each terminal apparatus 12 includes a communication interface 111, a memory 112, a controller 113, an input interface 115, an output interface 116, and an imager 117.

The communication interface 111 includes a communication module compliant with a wired or wireless LAN standard, a module compliant with a mobile communication standard such as LTE, 4G, or 5G, or the like. The terminal apparatus 12 connects to the network 11 via a nearby router apparatus or mobile communication base station using the communication interface 111 and communicates information with the server apparatus 10 and the like over the network 11.

The memory 112 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 112 functions as, for example, a main memory, an auxiliary memory, or a cache memory. The memory 112 stores information to be used for the operations of the controller 113 and information obtained by the operations of the controller 113.

The controller 113 has one or more general purpose processors, such as CPUs or Micro Processing Units (MPUs), or one or more dedicated processors, such as GPUs, that are dedicated to specific processing. Alternatively, the controller 113 may have one or more dedicated circuits such as FPGAs or ASICs. The controller 113 is configured to perform overall control of the operations of the terminal apparatus 12 by operating according to the control/processing programs or operating according to operation procedures implemented in the form of circuits. The controller 113 then transmits and receives various types of information to and from the server apparatus 10 and the like via the communication interface 111 and executes the operations according to the present embodiment.

The input interface 115 includes one or more interfaces for input. The interface for input may include, for example, a physical key, a capacitive key, a pointing device, and/or a touch screen integrally provided with a display. The interface for input may also include a microphone that accepts audio input and a camera that captures images. The interface for input may further include a scanner, camera, or IC card reader that scans an image code. The input interface 115 accepts operations for inputting information to be used in the operations of the controller 113 and transmits the inputted information to the controller 113.

The output interface 116 includes one or more interfaces for output. The interface for output may include, for example, a display or a speaker. The display is, for example, an LCD or an organic EL display. The output interface 116 functions as the “display” of the present embodiment. The output interface 116 outputs information obtained by the operations of the controller 113.

The imager 117 includes a camera that captures an image of a subject using visible light and a distance measuring sensor that measures the distance to the subject to acquire a distance image. The camera captures a subject at, for example, 15 to 30 frames per second to produce a moving image formed by a series of captured images. Distance measurement sensors include ToF (Time Of Flight) cameras, LiDAR (Light Detection And Ranging), and stereo cameras and generate distance images of a subject that contain distance information. The imager 117 transmits the captured images and the distance images to the controller 113.

The functions of the controller 113 are realized by a processor included in the controller 113 executing a control program. The control program is a program for causing the processor to function as the controller 113. Some or all of the functions of the controller 113 may be realized by a dedicated circuit included in the controller 113. The control program may be stored on a non-transitory recording/storage medium readable by the terminal apparatus 12 and be read from the medium by the terminal apparatus 12.

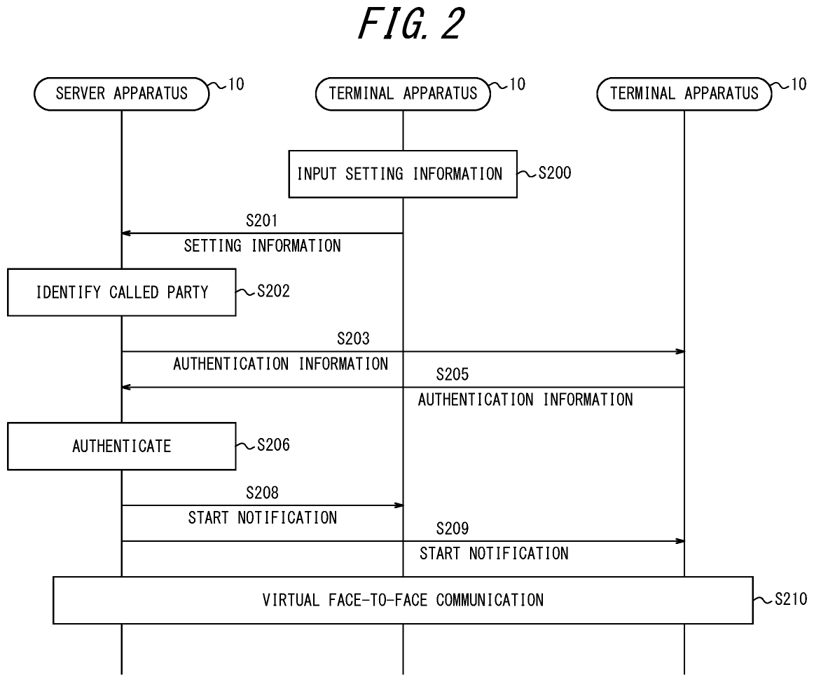

FIG. 2 is a sequence diagram illustrating the operating procedures of the virtual space call system 1. This sequence diagram illustrates the steps in the coordinated operation of the server apparatus 10 and the plurality of terminal apparatuses 12 (referred to as the terminal apparatus 12A and 12B when distinguishing therebetween). The terminal apparatus 12A is used by a user with the role of administrator of the virtual call event (user A). The terminal apparatus 12B is used by a user other than the administrator (user B). In a case of inviting a plurality of users B participating using respective terminal apparatuses 12B, the operating procedures for the terminal apparatus 12B illustrated here are performed by each terminal apparatus 12B, or by each terminal apparatus 12B and the server apparatus 10.

The steps pertaining to the various information processing by the server apparatus 10 and the terminal apparatuses 12 in FIG. 2 are performed by the respective controllers 103 and 113. The steps pertaining to transmitting and receiving various types of information to and from the server apparatus 10 and the terminal apparatuses 12 are performed by the respective controllers 103 and 113 transmitting and receiving information to and from each other via the respective communication interfaces 101 and 111. In the server apparatus 10 and the terminal apparatuses 12, the respective controllers 103 and 113 appropriately store the information that is transmitted and received in the respective memories 102 and 112. Furthermore, the controller 113 of the terminal apparatus 12 accepts input of various types of information with the input interface 115 and outputs various types of information with the output interface 116.

In step S200, the terminal apparatus 12A accepts input of call event setting information by the user A. The setting information includes, for example, a schedule of the call event and a list of users requesting to participate. The list of users includes the username and each user's email address. Here, the user B is included in the user list. In step S201, the terminal apparatus 12A then transmits the setting information to the server apparatus 10. The server apparatus 10 receives the information transmitted from the terminal apparatus 12A. For example, the terminal apparatus 12A accesses a site provided by the server apparatus 10 for conducting a call event, acquires an input screen for setting information, and displays the input screen to the user A. Then, once the user A inputs the setting information on the input screen, the setting information is transmitted to the server apparatus 10.

In step S202, the server apparatus 10 sets up a call event based on the setting information. The controller 103 stores information on the call event and information on the expected participants in association in the memory 102.

In step S203, the server apparatus 10 transmits authentication information to the terminal apparatus 12B. The authentication information is information used to identify and authenticate the user B who uses the terminal apparatus 12B, i.e., information such as an ID and passcode used when participating in a call event. Such information is, for example, transmitted as an e-mail attachment. The terminal apparatus 12B receives the information transmitted from the server apparatus 10.

In step S205, the terminal apparatus 12B transmits the authentication information received from the server apparatus 10 and information on a participation application to the server apparatus 10. The user B operates the terminal apparatus 12B and applies to participate in the call event using the authentication information transmitted by the server apparatus 10. For example, the terminal apparatus 12B accesses the site provided by the server apparatus 10 for the call event, acquires the authentication information and the input screen for the information on the participation application, and displays the input screen to the user B. The terminal apparatus 12B then accepts the information inputted by the user B and transmits the information to the server apparatus 10.

In step S206, the server apparatus 10 performs authentication on the user B, thereby completing registration for participation. The identification information for the terminal apparatus 12B and the identification information for the user B are stored in association in the memory 102.

In steps S208 and S209, the server apparatus 10 transmits an event start notification to the terminal apparatuses 12A and 12B. Upon receiving the information transmitted from the server apparatus 10, the terminal apparatuses 12A and 12B begin the imaging and collection of audio of speech for the respective user A and user B.

In step S210, a call event is conducted by the terminal apparatuses 12A and 12B via the server apparatus 10. The terminal apparatuses 12A and 12B transmit and receive information for generating 3D models representing user A and user B, respectively, and information on speech to each other via the server apparatus 10. The terminal apparatuses 12A and 12B output images of the call event, including the 3D models of each user, and speech of the other user to user A and user B, respectively.

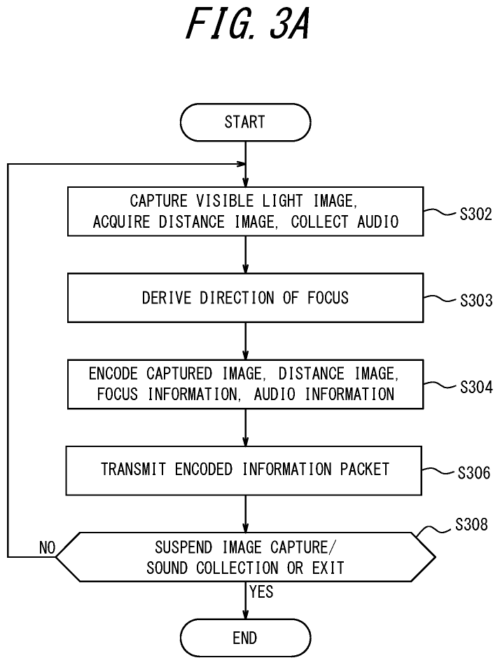

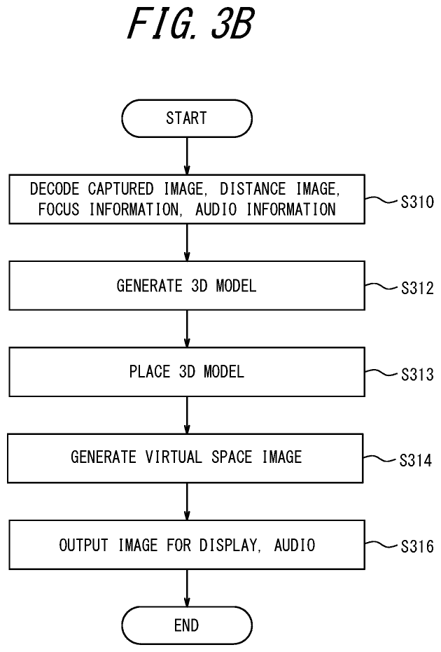

FIGS. 3A and 3B are flowcharts illustrating the operating procedures of the terminal apparatus 12 for conducting a call event. The procedures illustrated here are common to the terminal apparatuses 12A and 12B and are described without distinguishing between the terminal apparatuses 12A and 12B.

FIG. 3A relates to the operating procedures of the controller 113 when each terminal apparatus 12 transmits information for generating a 3D model of the user who uses that terminal apparatus 12.

In step S302, the controller 113 captures visible light images and acquires distance images of the corresponding user at an appropriately set frame rate using the imager 117 and collects audio of the corresponding user's speech using the input interface 115. The controller 113 acquires the images captured by visible light and the distance images from the imager 117 and the audio information from the input interface 115.

In step S303, the controller 113 derives the direction of focus of the corresponding user. The direction of focus is the direction in which the 3D model representing the corresponding user is focusing in the virtual space displayed on the other user's terminal apparatus 12. The direction of focus is specified by the 3D model, in the display image, on which the corresponding user is focusing (3D model of interest). The controller 113 uses any appropriate image processing and algorithm to detect the line of sight of the corresponding user from a captured image. The controller 113 identifies the 3D model of interest displayed in the direction of the corresponding user's line of sight based on the position of the display of the output interface 116 relative to the camera of the imager 117 and the position of the 3D model of the other user in the display image that is displayed on the display.

Information on the position of the display relative to the camera is stored in the memory 112 in advance. The controller 113 derives the moving speed of the corresponding user's line of sight based on the amount of displacement per unit time of the line of sight and identifies the 3D model located in the direction of the line of sight when the moving speed of the line of sight is less than any reference speed as the 3D model of interest. The controller 113 may identify the 3D model located in the direction of the line of sight as the 3D model of interest on the condition that the moving speed of the line of sight is less than the reference speed continuously for a reference time (for example, 3 to 10 seconds) or longer.

In step S304, the controller 113 encodes the captured image, the distance image, focus information, and audio information to generate encoded information. The focus information is information that identifies the 3D model of interest. The controller 113 may perform any appropriate processing (such as resolution change and trimming) on the captured images and the like at the time of encoding.

In step S306, the controller 113 converts the encoded information into packets using the communication interface 111 and transmits the packets to the server apparatus 10 for the other terminal apparatus 12.

Upon acquiring inputted information that corresponds to an operation by the corresponding user to suspend image capture and sound collection or to exit the call event (Yes in S308), the controller 113 terminates the processing procedure in FIG. 3A. While not acquiring information that corresponds to an operation for interruption or exit (No in S308), the controller 113 executes steps S302 to S306 to transmit, to the other terminal apparatus 12, information for generating a 3D model representing the corresponding user and information for outputting audio.

FIG. 3B relates to the operating procedures of the controller 113 when the terminal apparatus 12 outputs an image of the call event and audio of other users. Upon receiving, via the server apparatus 10, a packet transmitted by the other terminal apparatus 12 performing the procedures in FIG. 3A, the controller 113 performs steps S310 to S313.

In step S310, the controller 113 decodes the encoded information included in the packet received from another terminal apparatus 12 to acquire the captured image, distance image, focus information, and audio information.

In step S312, the controller 113 generates a 3D model representing each user based on the captured image and the distance image. In generating the 3D model, the controller 113 generates a polygon model using the distance images of the other user and applies texture mapping to the polygon model using the captured images of the other user, thereby generating the 3D model of the other user. This example is not limiting, however, and any appropriate method can be used to generate the 3D model.

In the case of receiving information from terminal apparatuses 12 of a plurality of other users, the controller 113 executes steps S310 to S312 for each other terminal apparatus 12 to generate the 3D model of each other user.

In step S313, the controller 113 places the 3D model representing each user in the virtual space where the call event is held. The controller 113 places the generated 3D models of the other users at the coordinates in the virtual space. The memory 112 stores, in advance, information on the coordinates of the virtual space and the coordinates at which the 3D models should be placed according to the order in which the users are authenticated, for example. The controller 113 places each 3D model, at the position where the 3D model is to be placed, to be rotated at an angle so as to face the respective direction of focus, i.e., the 3D model of interest. The 3D model of another user whose 3D model of interest is the 3D model of the corresponding user is placed to face a virtual viewpoint direction in the virtual space, i.e., at an angle to be opposite the corresponding user who views the display image when it is displayed.

In step S314, the controller 113 renders and generates a virtual space image in which the plurality of 3D models placed in the virtual space to face the corresponding direction of focus are captured from a virtual viewpoint.

In step S316, the controller 113 displays the image for display, and also outputs audio, using the output interface 116. In other words, the controller 113 outputs information, to the output interface 116, for displaying images of the virtual space in which 3D models are placed, i.e., display images. The output interface 116 displays the images for display and also outputs audio.

By the controller 113 repeatedly executing steps S310 to S316, the corresponding user can listen to the audio of speech of another user while watching a video of the virtual space images that include the 3D model of the corresponding user and the 3D model of the other user.

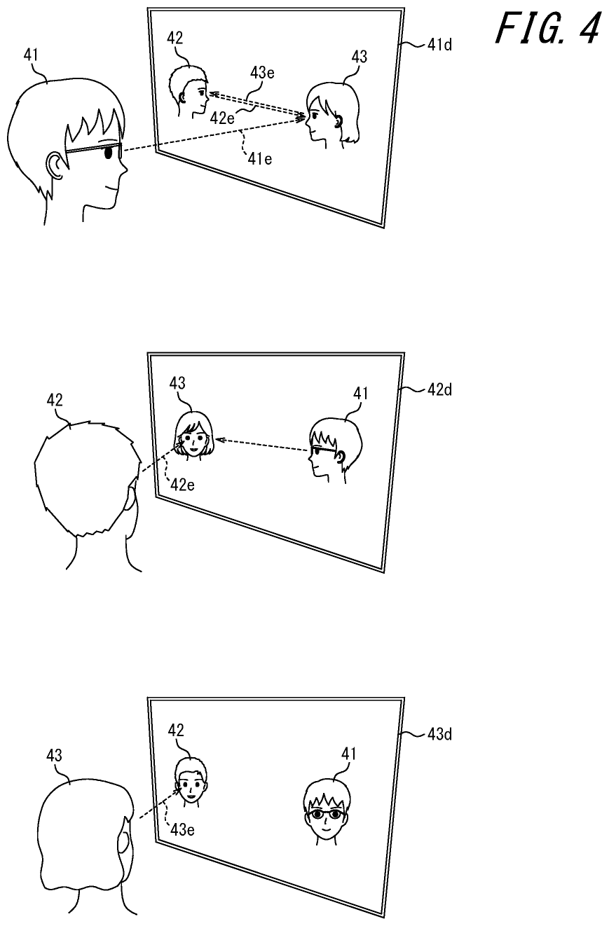

FIG. 4 illustrates an example of the displayed image. In FIG. 4, a display image 41d for user 41, a display image 42d for user 42, and a display image 43d for user 43 are illustrated for the case in which users 41, 42, and 43 call each other in a call event. Here, an example in which users 41 and 42 are focusing on user 43 and user 43 is focusing on user 42 is illustrated.

When user 41 looks at the display image 41d, a direction of focus 41e of user 41 directed toward user 43 is transmitted to the respective terminal apparatuses 12 of users 42 and 43 as focus information. The terminal apparatus 12 of user 41 displays a display image 41d such that user 42 faces user 43 and user 43 faces user 42, in correspondence with a direction of focus 42e of user 42 toward user 43 and a direction of focus 43e of user 43 toward user 42.

When user 42 looks at the display image 42d, the direction of focus 42e of user 42 directed toward user 43 is transmitted to the respective terminal apparatuses 12 of users 41 and 43 as focus information. The terminal apparatus 12 of user 42 displays a display image 42d such that user 41 faces user 43 in correspondence with the direction of focus 41e of user 41 toward user 43, and user 43 is opposite user 42 in correspondence with the direction of focus 43e of user 43 toward user 42.

When user 43 looks at the display image 43d, the direction of focus 43e of user 43 directed toward user 42 is transmitted to the respective terminal apparatuses 12 of users 41 and 42 as focus information. The terminal apparatus 12 of user 43 displays a display image 43d such that users 41 and 42 are opposite user 43, in correspondence with the directions of focus 41e and 42e of users 41 and 42 toward user 43.

In this way, by looking at the respective display images 41d, 42d, and 43d, the users 41, 42, and 43 can more realistically experience the relationship between other users in the call in which each user is participating and can more easily grasp and predict the development of the conversation. User convenience and the realistic feel of a call in virtual space can therefore be improved.

The steps for generating a 3D model from the captured image and distance image may be distributed between the steps in FIG. 3A and FIG. 3B, as appropriate. For example, a step in which the controller 113 generates a 3D model of the corresponding user may be inserted between steps S303 and S304 in FIG. 3A, and the data of the generated 3D model may be encoded and transmitted together with the focus information and audio information. In a case in which such encoded information is received from another terminal apparatus 12, the controller 113 can decode the data of the 3D model and place the 3D model in the virtual space according to the direction of focus.

In a variation, in a case in which the direction of focus derived in step S303 of FIG. 3A does not change for a freely set fixed time (for example, one to several seconds), the controller 113 encodes information indicating that the direction of focus has not changed together with audio information instead of the captured image, distance image, and focus information in step S304. In a case in which such encoded information is received from another terminal apparatus 12, then upon acquiring information indicating that the direction of focus has not changed in step S310 in FIG. 3B, the controller 113 uses the 3D model generated in a past processing cycle instead of generating a 3D model from the captured image and distance image and arranges the 3D model in the virtual space in step S313. In this case, the 3D model can be used without changing the orientation of the 3D model, since the direction of focus has not changed. According to such a variation, the processing load for encoding and decoding of captured images, distance images, and the like by the terminal apparatus 12A can be reduced.

In the above embodiment, the processing and control program that defines the operations by the controller 133 of the terminal apparatus 12 may be stored in the server apparatus 10 or in a memory of another server apparatus and downloaded to each terminal apparatus 12 via the network 11. The processing and control program may also be stored in a recording and storage medium that is readable by each terminal apparatus 12, and each terminal apparatus 12 may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A terminal apparatus comprising:
a communication interface; and
a controller configured to communicate using the communication interface, wherein
the controller is configured to receive information for generating a 3D model that represents another user who participates in a call in a virtual space using another terminal apparatus and also represents a direction of focus of the another user, and output information for displaying an image for display obtained by rendering the virtual space in which the 3D model is placed to be focusing in the direction of focus.

2. The terminal apparatus according to claim 1, further comprising
a display configured to display the image for display; and
an imager configured to capture images of a user viewing the image for display, wherein
the controller is configured to transmit information, to the another terminal apparatus, for generating a 3D model that represents the user and a direction of focus of the user based on a captured image of the user.

3. The terminal apparatus according to claim 2, wherein the image for display includes a 3D model representing one user and another 3D model representing another user who is focusing on the 3D model.

4. The terminal apparatus according to claim 2, wherein the controller is configured to determine a direction of a line of sight of the user, detected from the captured image, as the direction of focus when a moving speed of the line of sight is less than a reference speed.

5. The terminal apparatus according to claim 4, wherein the controller is configured to determine the direction of the line of sight as the direction of focus on a condition that the moving speed of the line of sight is less than the reference speed continuously for a reference time or longer.
